(19) United States
(12) Patent Application Publication
(10) Pub. No.: US 2016/0360407 A1
(43) Pub. Date: Dec. 8, 2016

(54) DISTRIBUTED CONFIGURATOR ENTITY

(71) Applicant: QUALCOMM Incorporated, San Diego, CA (US)

(72) Inventors: Olivier Jean Benoit, San Diego, CA (US); Peerapol Tinnakornsrisuphap, San Diego, CA (US)

(21) Appl. No.: 15/097,229

(22) Filed: Apr. 12, 2016

Related U.S. Application Data
(60) Provisional application No. 62/171,563, filed on Jun. 5, 2015.

(51) Int. Cl. H04W 12/06; H04L 29/06; H04W 12/04

(52) U.S. Cl. CPC H04W 12/06; H04W 12/04; H04L 63/08; H04W 84/12

(57) ABSTRACT

A system and method for distributed storage and/or management of network credentials in a wireless network. A first device of the wireless network receives a set of network credentials from a first configurator. The network credentials may be used to authorize one or more devices to access the wireless network. The first device further receives a user authentication credential from a second device, and authenticates the second device as a second configurator for the wireless network based at least in part on the user authentication credential. Upon authenticating the second device as the second configurator, the first device may then transmit the set of network credentials to the second configurator.

### CROSS-REFERENCE TO RELATED APPLICATION

This application claims priority to U.S. Provisional Patent Application No. 62/171,563 entitled “SYSTEM AND METHOD FOR DISTRIBUTION AND MANAGEMENT OF NETWORK CREDENTIALS” filed Jun. 5, 2015, the entirety of which is incorporated by reference herein.

### TECHNICAL FIELD

The example embodiments relate generally to wireless networks, and specifically to a distributed storage and/or management of network credentials in a wireless network.

### BACKGROUND OF RELATED ART

A client device (e.g., wireless station) may be configured to communicate with one or more access points (APs) of a wireless network using public key encryption techniques. Public key encryption (sometimes referred to as public/private key encryption) is a method of securely transferring data using a known (public) key and a secret (private) key. Each device may have a unique pair of public and private keys that are mathematically and/or algorithmically related to one another. In addition to transferring data, the public and private keys may be used to verify messages and certificates and/or generate digital signatures. For example, the client device may share its public key with the APs within the wireless network. The APs may use the client device's public key to authenticate and configure the client device to access (e.g., connect to) the wireless network. The authenticated client device may communicate with the APs and/or other devices within the wireless network.

In some wireless networks, a configurator may manage the network credentials of each device in the network. For example, the configurator may enroll and/or authenticate members (e.g., client devices and APs) of a wireless network based on the public/private keys associated with each device. More specifically, the configurator may store at least the public key information for each client device and/or AP in the wireless network. The configurator may use the stored public key information (e.g., network credentials) to communicate securely with each of the client devices and APs in the wireless network. The configurator may configure and/or provision client devices, for example, by providing the client devices with information to identify and/or communicate with the APs. Similarly, the configurator may provide the APs with information to identify and/or authenticate communications from the client devices.

The configurator is typically a smart phone or other portable device that may be lost, stolen, replaced, or otherwise removed (e.g., permanently) from the wireless network. Thus, it may be desirable to maintain the membership of the wireless network, in the absence of the configurator, without having to re-enroll each member device.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

A system and method for distributed storage and/or management of network credentials in wireless network is disclosed. A first device of the wireless network receives a set of network credentials from a first configurator. The network credentials are for authorizing one or more devices to access the wireless network. For example, the network credentials may include a list of trusted public keys associated with the one or more devices. Alternatively, or in addition, the network credentials may include a pair of public and private keys used to certify the one or more devices as members of the wireless network. The first device further receives a user authentication credential from a second device, and authenticates the second device as a second configurator for the wireless network based at least in part on the user authentication credential. Upon authenticating the second device as the second configurator, the first device may then transmit the set of network credentials to the second configurator.

In example embodiments, the user authentication credential may be used to verify that the first configurator and the second device belong to, or are otherwise used by, the same user. For example, the user authentication credential may include at least one of a password, voice data, or image data input by a user of the second device. The first device may receive a reference credential from the first configurator and compare the reference credential with the user authentication credential. In some aspects, the first device may offload the comparison to be performed by one or more processing resources external to the wireless network. More specifically, the first device may authenticate the second device as the second configurator upon determining that the user authentication credential substantially matches the reference credential.

Still further, in some embodiments, the first device may establish a secure channel with the second device based at least in part on a public identity key of the first device. For example, the public identity key may be provided to the first device in an out-of-band manner. Accordingly, the first device may receive the user authentication credential from the second device via the secure channel. Once authenticated, the second configurator may authorize additional devices to access the wireless network.

By distributing the network credentials among multiple devices in a wireless network, the example embodiments provide redundancy in managing access to the wireless network. For example, this may allow an access point (AP) storing a redundant set of network credentials to on-board new configurators in the event that the existing configurator becomes lost, stolen, replaced, or otherwise permanently removed from the wireless network. Furthermore, the user authentication credential allows configurators to be authenticated based on their users (e.g., rather than the devices themselves). This may ensure a greater level of “trustworthiness” when on-boarding a new configurator, for example, by verifying that the user of the new configurator is the same as the user of the old or existing configurator.

### BRIEF DESCRIPTION OF THE DRAWINGS

The example embodiments are illustrated by way of example and are not intended to be limited by the figures of the accompanying drawings.

FIG. 1 shows a block diagram of a wireless system within which the example embodiments may be implemented.

FIG. 2 shows a block diagram of a system for distributing network credentials among multiple devices, in accordance with example embodiments.

FIG. 3 is a sequence diagram depicting an operation for on-boarding a new configurator for a wireless network, in accordance with example embodiments.

FIG. 4 shows a block diagram of an access point in accordance with example embodiments.

FIG. 5 shows a block diagram of a wireless device in accordance with example embodiments.

FIG. 6 shows an illustrative flowchart depicting an operation for distributing network credentials for a wireless network, in accordance with example embodiments.

FIG. 7 shows an illustrative flowchart depicting an operation for on-boarding a new configurator in a wireless network, in accordance with example embodiments.

### DETAILED DESCRIPTION

The example embodiments are described below in the context of WLAN systems for simplicity only. It is to be understood that the example embodiments are equally applicable to other wireless networks (e.g., cellular networks, pico networks, femto networks, satellite networks), as well as for systems using signals of one or more wired standards or protocols (e.g., Ethernet and/or HomePlug/PLC standards). As used herein, the terms “WLAN” and “Wi-Fi®” may include communications governed by the IEEE 802.11 family of standards, BLUETOOTH® (Bluetooth), HiperLAN (a set of wireless standards, comparable to the IEEE 802.11 standards, used primarily in Europe), and other technologies having relatively short radio propagation range. Thus, the terms “WLAN” and “Wi-Fi” may be used interchangeably herein. In addition, although described below in terms of an infrastructure WLAN system including one or more APs and a number of client devices, the example embodiments are equally applicable to other WLAN systems including, for example, multiple WLANs, peer-to-peer (or Independent Basic Service Set) systems, Wi-Fi Direct systems, and/or Hotspots.

In the following description, numerous specific details are set forth such as examples of specific components, circuits, and processes to provide a thorough understanding of the present disclosure. The term “coupled” as used herein means connected directly to or connected through one or more intervening components or circuits. The term “configurator” refers to a wireless device that manages and/or controls access to a wireless network. For example, the configurator may enroll or authorize new members to join the wireless network, and may de-authorize existing members from joining the wireless network. A “member” or “member device” refers to any wireless device (e.g., client device or AP) authorized, by the configurator, to access a particular wireless network.

Also, in the following description and for purposes of explanation, specific nomenclature is set forth to provide a thorough understanding of the example embodiments. However, it will be apparent to one skilled in the art that these specific details may not be required to practice the example embodiments. In other instances, well-known circuits and devices are shown in block diagram form to avoid obscuring the present disclosure. Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. Also, the example wireless communications devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as one or more digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structure or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

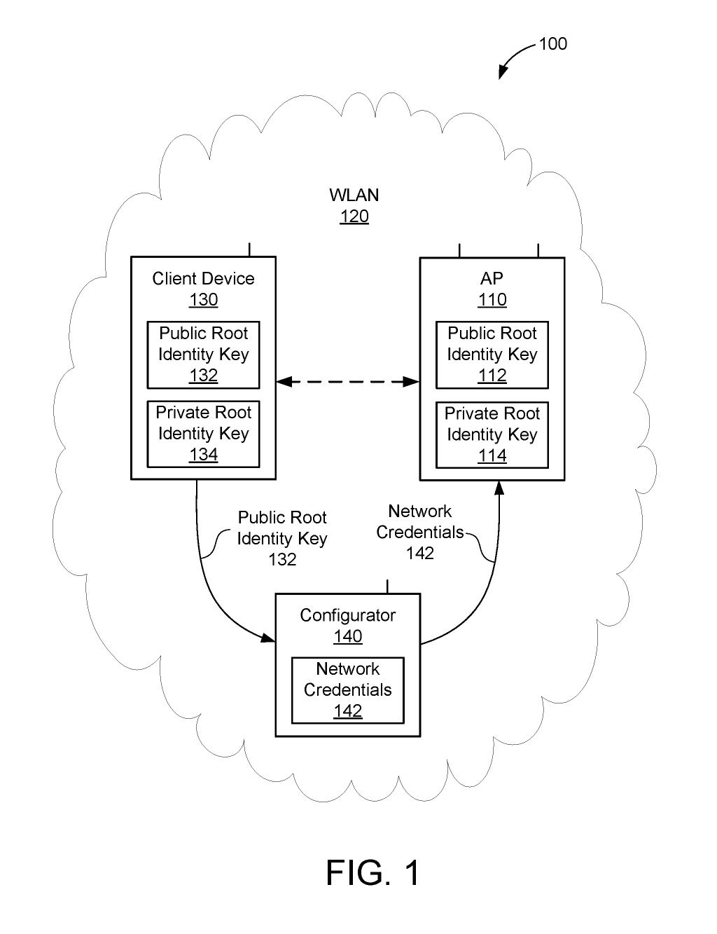

FIG. 1 is a block diagram of a wireless system 100 within which the example embodiments may be implemented. The wireless system 100 may include a wireless access point (AP) 110, a wireless local area network (WLAN) 120, a client device 130 (e.g., a station or STA), and a configurator 140. The WLAN 120 may be formed by a plurality of Wi-Fi access points (APs) that may operate according to the IEEE 802.11 family of standards (or according to other suitable wireless protocols). Thus, although only one AP 110 is shown in FIG. 1 for simplicity, it is to be understood that the WLAN 120 may be formed by any number of access points such as AP 110. Similarly, the WLAN 120 may include any number of client devices such as client device 130. For some embodiments, the wireless system 100 may correspond to a single user multiple-input multiple-output (SU-MIMO) or a multi-user MIMO (MU-MIMO) wireless network. Although the WLAN 120 is depicted in FIG. 1 as an infrastructure basic service set (BSS), for other example embodiments, the WLAN 120 may be an independent basic service set (IBSS), an ad-hoc network, or a peer-to-peer (P2P) network (e.g., operating in accordance with the Wi-Fi Direct specification).

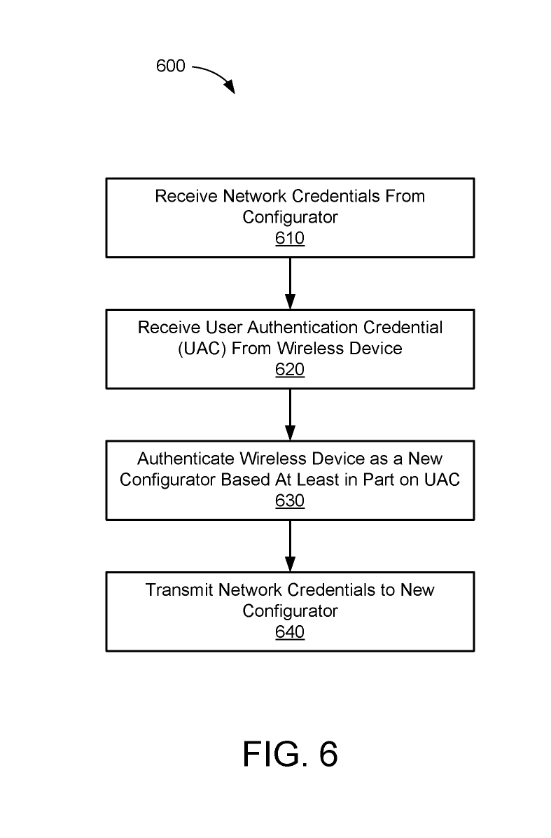

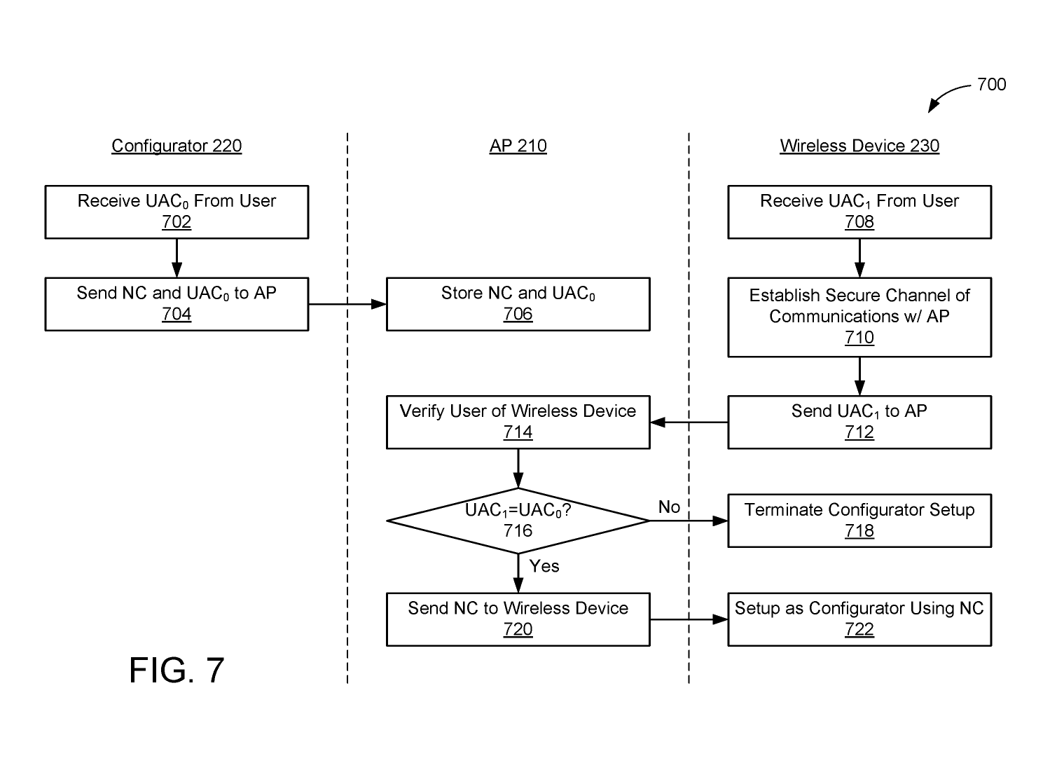

The AP 110 may be any suitable device that allows one or more wireless devices to connect to a network (e.g., a local area network (LAN), wide area network (WAN), metropolitan area network (MAN), and/or the Internet) via AP 110 using Wi-Fi, Bluetooth, or any other suitable wireless communication standards. The AP 110 is assigned a unique media access control (MAC) address that is programmed therein by, for example, a device manufacturer. For some embodiments, the AP 110 may be any suitable wireless device (e.g., cell phone, PDA, tablet device, laptop computer, and/or STA) acting as a software-enabled access point (“SoftAP”). For at least one embodiment, AP 110 may include one or more transceivers, one or more processing resources (e.g., processors and/or ASICs), one or more memory resources, and a power source. The memory resources may include a non-transitory computer-readable medium (e.g., one or more nonvolatile memory elements, such as EPROM, EEPROM, Flash memory, a hard drive, etc.) that stores instructions for performing operations described below with respect to FIGS. 6 and 7.

The client device 130 may be any suitable Wi-Fi enabled wireless device including, for example, a cell phone, personal digital assistant (PDA), tablet device, laptop computer, or the like. The client device 130 may also be referred to as a user equipment (UE), a subscriber station, a mobile unit, a subscriber unit, a wireless unit, a remote unit, a mobile device, a wireless communications device, a remote device, a mobile subscriber station, an access terminal, a mobile terminal, a wireless terminal, a remote terminal, a handset, a user agent, a mobile client, a client, or some other suitable terminology. The client device 130 is also assigned a unique MAC address. For at least some embodiments, the client device 130 may include one or more transceivers, one or more processing resources (e.g., processors and/or ASICs), one or more memory resources, and a power source (e.g., a battery). The memory resources may include a non-transitory computer-readable medium (e.g., one or more nonvolatile memory elements, such as EPROM, EEPROM, Flash memory, a hard drive, etc.) that stores instructions for performing operations described below with respect to FIG. 7.

The configurator 140 may be any suitable device that can communicate securely with the client device 130 and AP 110. In example embodiments, the configurator 140 may communicate with each of the client device 130 and AP 110 using public key encryption techniques and/or in accordance with a Device Provisioning Protocol (DPP). For at least some embodiments, the configurator 140 may include user input features (e.g., touchscreen, keyboard, microphone, etc.) for receiving inputs from a user or operator of the device. For example, the configurator 140 may be a smartphone, personal digital assistant (PDA), tablet device, laptop computer, or the like. Further, for some embodiments, the configurator 140 may include one or more transceivers, one or more processing resources (e.g., processors and/or ASICs), one or more memory resources, and a power source (e.g., a battery). The memory resources may include a non-transitory computer-readable medium (e.g., one or more nonvolatile memory elements, such as EPROM, EEPROM, Flash memory, a hard drive, etc.) that stores instructions for performing operations described below with respect to FIG. 7.

For the AP 110, the client device 130, and the configurator 140, the one or more transceivers may include Wi-Fi transceivers, Bluetooth transceivers, cellular transceivers, and/or other suitable radio frequency (RF) transceivers (not shown for simplicity) to transmit and receive wireless communication signals. Each transceiver may communicate with other wireless devices in distinct operating frequency bands and/or using distinct communication protocols. For example, the Wi-Fi transceiver may communicate within a 2.4 GHz frequency band and/or within a 5 GHz frequency band in accordance with the IEEE 802.11 specification. The cellular transceiver may communicate within various RF frequency bands in accordance with a 4G Long Term Evolution (LTE) protocol described by the 3rd Generation Partnership Project (3GPP) (e.g., between approximately 700 MHz and approximately 3.9 GHz) and/or in accordance with other cellular protocols (e.g., a Global System for Mobile (GSM) communications protocol). In other embodiments, the transceivers included within the client device may be any technically feasible transceiver such as a ZigBee transceiver described by a specification from the ZigBee Alliance, a WiGig transceiver, and/or a HomePlug transceiver described by a specification from the HomePlug Alliance.

The configurator 140 manages access to and/or control of the WLAN 120. For example, the configurator 140 may store a set of network credentials 142 that may be used to authorize member devices to access the WLAN 120. In some aspects, the configurator 140 may enroll and/or authorize new devices to join (e.g., and become members of) the WLAN 120. For example, before the client device 130 can access any services and/or devices of the WLAN 120, the configurator 140 may first enroll the client device 130 as a member of the WLAN 120. The enrollment process may include authenticating the client device 130 as a “trusted” device, and provisioning the client device 130 to communicate with the AP 110 and/or other members of the WLAN 120. For purposes of discussion, it is assumed that the AP 110 is already enrolled (e.g., by the configurator 140) as a member of the WLAN 120.

In example embodiments, the configurator 140 may authenticate the client device 130 using public key encryption techniques. Public key encryption techniques may be used to establish a secure communications channel between the configurator 140 and the client device 130. For example, the client device 130 may store, or otherwise be associated with, a public root identity key 132 and a private root identity key 134. The public/private key pair 132 and 134 may be programmed and/or stored in the client device 130 at its time of manufacture. The public root identity key (or public key) 132 may be distributed to other devices (e.g., including the configurator 140), whereas the private root identity key (or private key) 134 may be known only to the client device 130. The configurator 140 may use the public root identity key 132 to encrypt messages intended for the client device 130, and the client device 130 may decrypt the messages using its private root identity key 134.

To ensure that the client device 130 is a “trusted” device, the configurator 140 may obtain the public root identity key 132 in an out-of-band manner (e.g., using quick response (QR) codes, near-field communication (NFC), label strings, Bluetooth low energy (BLE), Universal Serial Bus (USB), etc.). For example, the configurator 140 may acquire the public root identity key 132 by scanning (e.g., with an optical device and/or camera) a QR code printed on a surface or housing of the client device 130. Alternatively, the public root identity key 132 may be manually input by a user of the configurator 140 (e.g., after reading it off a printed label on the client device 130). Still further, in some aspects, the client device 130 may send its public root identity key 132 to the configurator 140 over a short-range communications channel (e.g., NFC, BLE, USB, etc.). The out-of-band manner in which configurator 140 obtains the public root identity key 132 ensures that the client device 130 is within a relatively close proximity of the configurator 140 during the authentication process. The configurator 140 can therefore trust that the client device 130 is indeed the device it is supposed to be.

During the authentication process, the configurator 140 may set up a secure communications channel with the client device 130 using public key encryption. For example, the configurator 140 may exchange encrypted messages with the client device 130 to verify that the client device 130 is in possession of the private root identity key 134 associated with the public root identity key 132, and to provide its own public root identity key (not shown for simplicity) to the client device 130. Once authenticated, the client device 130 may send messages securely to the configurator 140 (e.g., using the public root identity key 132 of the configurator 140), and the configurator 140 may send messages securely to the client device 130 (e.g., using the public root identity key 132).

The configurator 140 may then configure the client device 130 to access and/or connect to the WLAN 120. For example, the configurator 140 may “introduce” the client device 130 to other devices in the WLAN 120 including, for example, the AP 110. In some aspects, the configurator 140 may also communicate with the AP 110 using public key encryption, for example, based on a public root identity key 112 and a private root identity key 114 of the AP 110. By introducing the client device 130 and the AP 110, the configurator 140 certifies that both devices are authenticated (e.g., trusted) members of the WLAN 120. The client device 130 and AP 110 may then negotiate a shared pairwise master key (PMK) that may be used to establish a secure communication link between the devices. For example, the client device 130 may use the PMK to access and/or connect to the WLAN 120 (e.g., via a 4-way handshake as defined by the IEEE 802.11 specification).

In some aspects, the configurator 140 may control access to the WLAN 120 using a public key whitelist-based access control technique. For example, the configurator 140 may store a list of trusted (e.g., member) devices that are authorized to access and/or join the WLAN 120. The list of trusted devices may be stored as the set of the network credentials 142. In some embodiments, the network credentials 142 may include identity key information for each member of the WLAN 120. In the example of FIG. 1, the network credentials 142 may include the public root identity key 132 of the client device 130 and a public root identity key 112 of the AP 110. Accordingly, the configurator 140 may limit access to the WLAN 120 to only those devices identified by the network credentials 142 (e.g., member devices).

In other aspects, the configurator 140 may control access to the WLAN 120 using a certificate-based access control technique. For example, the configurator 140 may use a pair of certification authority (CA) public and private keys (not shown for simplicity) to sign and/or certify communications by member devices of the WLAN 120. In some embodiments, the network credentials 142 may include the CA public/private key pair used to certify members of the WLAN 120. Thus, the configurator 140 may distribute the CA public key to member devices (e.g., client device 130 and AP 110) of the WLAN 120, and may use the CA private key to sign or encrypt communications by the member devices. This ensures that only member devices of the WLAN 120 (e.g., devices in possession of the CA public key) may decrypt and/or verify communications by other member devices (e.g., communications signed using the CA private key).

In example embodiments, the configurator 140 may distribute copies of the network credentials 142 to other devices in the WLAN 120. As described above, the configurator 140 may be lost stolen, replaced, or otherwise removed (e.g., permanently) from the WLAN 120. The example embodiments also recognize that access points tend to be relatively permanent fixtures in a wireless network, and are less likely to be lost or stolen. Thus, in example embodiments, the configurator 140 may transfer a copy of the network credentials 142 to be stored on the AP 110. Although only one entity (e.g., AP 110) is shown receiving the network credentials 142 in the example of FIG. 1, in other embodiments, the configurator 140 may distribute the network credentials 142 to any number of devices (e.g., APs and/or client devices) in the WLAN 120. For example, in some embodiments, the configurator 140 may distribute the network credentials 142 to the AP 110 and/or client device 130.

Storing the network credentials 142 in a distributed manner (e.g., on multiple devices in the WLAN 120) may provide redundancy in managing access to the WLAN 120. Although the AP 110 may be less likely (than the configurator 140) to become lost, stolen, or removed from the WLAN 120, the AP 110 may also have a less robust feature set than the configurator 140. For example, the AP 110 may not have a camera, Bluetooth radio, user input device, and/or other features necessary to enroll and/or manage devices using the network credentials 142. Thus, for some embodiments, the AP 110 may transfer the network credentials 142 to another wireless device (not shown for simplicity) and enable the wireless device to assume the role of a configurator for the WLAN 120.

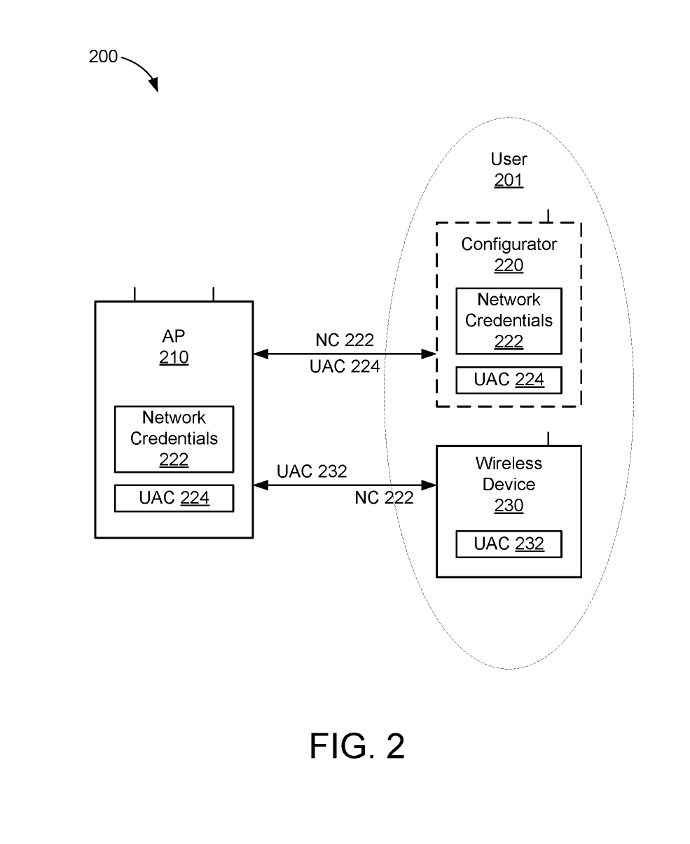

FIG. 2 shows a block diagram of a system 200 for distributing network credentials among multiple devices, in accordance with example embodiments. The system 200 includes an AP 210, a configurator 220, and a wireless device 230. The AP 210 and configurator 220 may be embodiments of AP 110 and configurator 140, respectively, of FIG. 1.

The configurator 220 manages access to and/or control of a wireless network (not shown for simplicity) provided, at least in part, by the AP 210. More specifically, the configurator 220 stores a set of network credentials (NC) 222 that may be used to provide and/or limit access to the wireless network to trusted and/or authenticated devices (e.g., members of the wireless network). In some aspects, the network credentials 222 may include a list of public root identity keys for trusted member devices (e.g., for public key whitelist-based access control). In other aspects, the network credentials 222 may include a pair of CA public and private keys that may be used by the configurator 220 (e.g., or other certification authority) to sign and/or certify communications by member devices (e.g., for certificate-based access control).

In example embodiments, the AP 210 may also store a copy of the network credentials 222 used by the configurator 220 to manage access to the wireless network. For example, the configurator 220 may store a copy of the network credentials 222 on the AP 210 upon enrolling the AP 210 as a member of the wireless network. To maintain synchronization of the network credentials 222 between the AP 210 and configurator 220, the configurator 220 may periodically update the network credentials 222 stored on the AP 210 to reflect any additions and/or removals of member devices during a given period. Alternatively, the configurator 220 may update the network credentials 222 stored on the AP 210 in response to any changes to the membership of the wireless network.

The wireless device 230 may be any suitable device capable of communicating securely with the AP 210 and managing access to the wireless network. For example, the wireless device 230 may communicate with the AP 210 using public key encryption techniques and/or in accordance with a DPP protocol. For at least some embodiments, the wireless device 230 may include user input features (e.g., touchscreen, keyboard, microphone, etc.) for receiving inputs from a user or operator of the device. For example, the wireless device 230 may be a smartphone, PDA, tablet device, laptop computer, or the like. Further, the wireless device 230 may include one or more transceivers, one or more processing resources, one or more memory resources, and a power source. The memory resources may include a non-transitory computer-readable medium (e.g., one or more nonvolatile memory elements, such as EPROM, EEPROM, Flash memory, a hard drive, etc.) that stores instructions for performing operations described below with respect to FIG. 7.

In example embodiments, the AP 210 may “on-board” (e.g., set up or configure) the wireless device 230 as a configurator for the wireless network. For example, the wireless device 230 may serve as a backup and/or provide redundancy for the configurator 220. In addition, the wireless device 230 may assume the role of the configurator 220 (e.g., and thus maintain the membership of the wireless network) in the event that the configurator 220 becomes lost, stolen, replaced, and/or otherwise removed from the wireless network. The AP 210 may set up the wireless device 230 as a configurator by further distributing a copy of the network credentials 222 to the wireless device 230. For some embodiments, the AP 210 may first determine that the wireless device 230 is a “trusted” device before transferring the network credentials 222 to the wireless device 230. However, without the configurator 220 present, the AP 210 may be unable to determine the trustworthiness of the wireless device 230 through the member enrollment process (e.g., using DPP authentication).

The example embodiments recognize that a particular user 201 may own and/or operate both the configurator 220 and the wireless device 230. Thus, in example embodiments, the AP 210 may determine the trustworthiness of the wireless device 230 by authenticating the user 201 of the wireless device 230 (e.g., or authenticating the wireless device 230 based on the user 201 in possession of and/or operating the device). For example, the AP 210 may receive and/or request a user authentication credential (UAC) 224 from the configurator 220 upon receiving the network credentials 222. The user authentication credential 224 may include any information that uniquely identifies the user 201 as the owner and/or operator of the configurator 220. To verify that the user 201 is in possession of the configurator 220, the AP 210 may request the user 201 to manually input and/or provide the user authentication credential 224 upon receiving the network credentials 222 form the configurator 220.

In some embodiments, the user authentication credential 224 may include an alphanumeric password. For example, the AP 210 may prompt the user 201 to enter or input a password via a keyboard or touchscreen of the configurator 220. In other embodiments, the authentication credential 224 may include an audio recording and/or voice data. For example, the AP 210 may prompt the user 201 to repeat a phrase displayed on a screen and/or surface of the configurator 220, while a microphone of the configurator 220 records the user's voice. Still further, in some embodiments, the user authentication credential 224 may include a photo and/or image data. For example, the AP 210 may cause a camera or optical device of the configurator 220 to capture a photo of the user 201.

The AP 210 may store the user authentication credential 224 in connection with the network credentials 222. In some embodiments, the AP 210 may subsequently use the user authentication credential 224 to authenticate the wireless device 230 as a configurator for the wireless network. For example, when attempting to on-board the wireless device 230, the user 201 of the wireless device 230 may be prompted to input or provide another user authentication credential (UAC) 232 via one or more input features (e.g., microphone, camera, touchscreen, keyboard, etc.) of the wireless device 230. The wireless device 230 then sends the user authentication credential 232 to the AP 210 for authentication purposes.

The AP 210 may compare the user authentication credential 232 from the wireless device 230 with the user authentication credential 224 received from the configurator 220 to determine whether the same user 201 is the owner and/or operator of both the configurator 220 and the wireless device 230. If the AP 210 determines that the user authentication credential 232 from the wireless device 230 substantially matches the user authentication credential 224 from the configurator 220, the AP 210 may distribute the network credentials 222 to the wireless device 230 and enable the wireless device 230 to assume the role of a configurator for the wireless network.

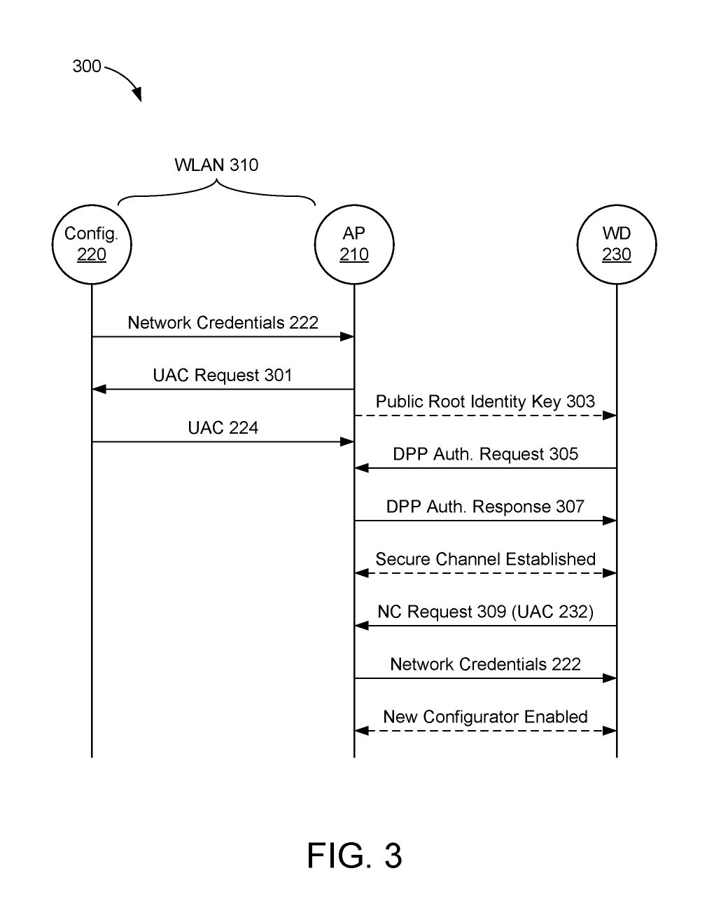

FIG. 3 is a sequence diagram 300 depicting an operation for on-boarding a new configurator for a wireless network, in accordance with example embodiments. With reference, for example, to the system 200 of FIG. 2, the AP 210 may initially communicate with the configurator 220 as a member of a WLAN 310.

Upon establishing a secure communication channel with the AP 210, the configurator 220 may distribute a copy of the network credentials 222 to be stored on or by the AP 210. The configurator 220 may transmit the network credentials 222 to the AP 210 via a secure communications channel. For example, in some aspects, the configurator 220 may encrypt the network credentials 222 using public key encryption techniques. In other aspects, the configurator 220 may transmit the network credentials 222 over a wireless channel of the wireless network.

In example embodiments, the AP 210 may request a user authentication credential (UAC) from a user of the configurator 220 upon receiving the network credentials 222. For example, the AP 210 may send a UAC request 301 to the configurator 220. The UAC request 301 may cause the configurator 220 to prompt the user 201 to input or provide the user authentication credential 224. As described above, the user authentication credential 224 may include an alphanumeric password, a voice recording, image, and/or other information that uniquely identifies the user 201 of the configurator 220. The configurator 220 then forwards the user authentication credential 224 to the AP 210, to be stored in connection with the network credentials 222.

In the example of FIG. 3, the wireless device (WD) 230 is initially not a member of the WLAN 310. Thus, before the wireless device 230 can be set up as a configurator for the WLAN 310, the wireless device 230 may first establish a secure channel for communicating with the AP 210. For some embodiments, the wireless device 230 may establish the secure channel in accordance with the DPP authentication protocol (e.g., as described above with respect to FIG. 1). For example, the wireless device 230 may first acquire a public root identity key 303 of the AP 210. For some embodiments, the wireless device 230 may acquire and/or receive the public root identity key 303 from the AP 210 in an out-of-band manner (e.g., using a QR code, BLE communication, NFC communication, USB connection, label string, etc.) to ensure that the AP 210 is a trusted device.

The wireless device 230 may then use the public root identity key 303 of the AP 210 to establish a secure channel of communication with the AP 210. For example, the wireless device 230 may provide its own public root identity key to the AP 210 via a DPP authentication request 305. The DPP authentication request 305 may be encrypted using the public root identity key 303 of the AP 210, and may thus be decrypted only if the AP 210 possess the corresponding (e.g., counterpart) private root identity key. The AP 210 may then send a DPP authentication response 307 back to the wireless device 230 to confirm or otherwise indicate to the wireless device 230 that the AP 210 successfully received (and decrypted) the DPP authentication request 305. At this time, the wireless device 230 may communicate securely with the AP 210 (e.g., using the public root identity key 303 of the AP 210), and the AP 210 may communicate securely with the wireless device 230 (e.g., using the public root identity key of the wireless device 230).

After the secure communications channel is established, the wireless device 230 may request a set of network credentials (NC) from the AP 210. For example, the wireless device 230 may send an NC request 309 to the AP 210 to retrieve a copy of the network credentials 222. In example embodiments, the NC request 309 may include the user authentication credential 232 input by the user 201 of the wireless device 230. To ensure the authenticity of the user authentication credential 232, the wireless device 230 may prompt the user 201 to input or provide the user authentication credential 232 upon triggering and/or generating the NC request 309.

The AP 210 may authenticate the user 201 of the wireless device 230 by comparing the user authentication credential 232 from the wireless device 230 with the user authentication credential 224 previously received from the configurator 220. Upon verifying that the user 201 of the wireless device 230 is the same as the user of the configurator 220, the AP 210 may transmit a copy of the network credentials 222 to the wireless device 230 and enable the wireless device 230 to operate as a configurator for the WLAN 310. Accordingly, the wireless device 230 may provide redundancy for the configurator 220 and/or preserve the membership of the WLAN 310 in the event the configurator 220 becomes lost, stolen, replaced, or otherwise removed from the WLAN 310.

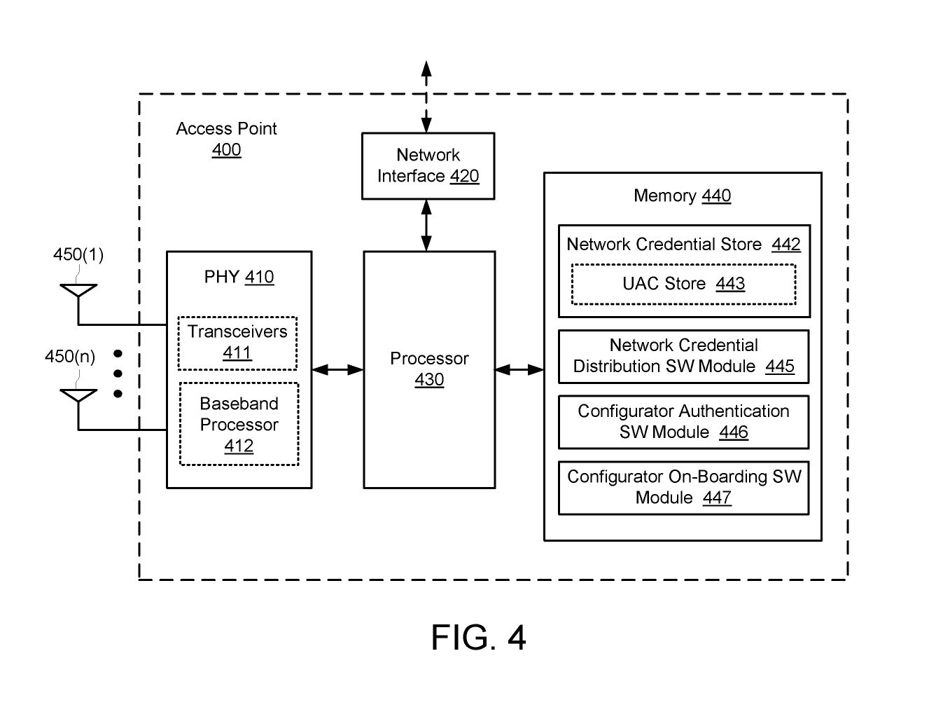

FIG. 4 shows a block diagram of an access point (AP) 400 in accordance with example embodiments. The AP 400 may be one embodiment of AP 110 of FIG. 1 and/or AP 210 of FIG. 2. The AP 400 includes at least a PHY device 410, a network interface 420, a processor 430, memory 440, and a number of antennas 450(1)-450(n). The network interface 420 may be used to communicate with a WLAN server (not shown for simplicity) either directly or via one or more intervening networks, and to transmit signals.

The PHY device 410 includes at least a set of transceivers 411 and a baseband processor 412. The transceivers 411 may be coupled to antennas 450(1)-450(n), either directly or through an antenna selection circuit (not shown for simplicity). The transceivers 411 may be used to transmit signals to and receive signals from other wireless devices (e.g., APs, client devices, and/or other wireless devices), and may be used to scan the surrounding environment to detect and identify nearby wireless devices (e.g., within wireless range of the AP 400). The baseband processor 412 may be used to process signals received from processor 430 and/or memory 440 and to forward the processed signals to transceivers 411 for transmission via one or more antennas 450(1)-450(n). The baseband processor 412 may also be used to process signals received from one or more antennas 450(1)-450(n) via transceivers 411 and to forward the processed signals to the processor 430 and/or memory 440.

Memory 440 may include a network credential store 442 that stores a set of network credentials used for authorizing devices (e.g., member devices) to access the WLAN. In some aspects, the network credential store 442 may store identity key information (e.g., public root identity keys) for each member of the WLAN (e.g., for public key whitelist-based access control). In other aspects, the network credential store 442 may store a pair of certification authority (CA) public and private keys that may be used to certify communications by member devices (e.g., for certificate-based access control). For some embodiments, the network credential store 442 may include a user authentication credential (UAC) store 443 to store a user authentication credential to be associated with the network credentials. For example, the user authentication credential may include a password, voice data, image data, and/or other information that uniquely identifies a user of a wireless device.

Memory 440 may also include a non-transitory computer-readable medium (e.g., one or more nonvolatile memory elements, such as EPROM, EEPROM, Flash memory, a hard drive, etc.) that may store at least the following software (SW) modules:

a network credential distribution SW module 445 to acquire and/or distribute the network credentials stored in the network credential store 442 among members of the WLAN;

a configurator authentication SW module 446 to authenticate a wireless device as a new configurator for the WLAN based at least in part on the user authentication credential; and

a configurator on-boarding SW module 447 to provide the network credentials stored in the network credential store 442 to the new configurator, and to enable the new configurator to manage and/or control access to the WLAN.

Each software module includes instructions that, when executed by the processor 430, cause the AP 400 to perform the corresponding functions. The non-transitory computer-readable medium of memory 440 thus includes instructions for performing all or a portion of the operations depicted in FIG. 6 and/or the AP-side operations depicted in FIG. 7.

Processor 430 may be any suitable one or more processors capable of executing scripts or instructions of one or more software programs stored in the AP 400 (e.g., within memory 440). For example, processor 430 may execute the network credential distribution SW module 445 to acquire and/or distribute the network credentials stored in the network credential store 442 among members of the WLAN. The processor 430 may also execute the configurator authentication SW module 446 to authenticate a wireless device as a new configurator for the WLAN based at least in part on the user authentication credential. Still further, the processor 430 may execute the configurator on-boarding SW module 447 to provide the network credentials stored in the network credential store 442 to the new configurator, and to enable the new configurator to manage and/or control access to the WLAN.

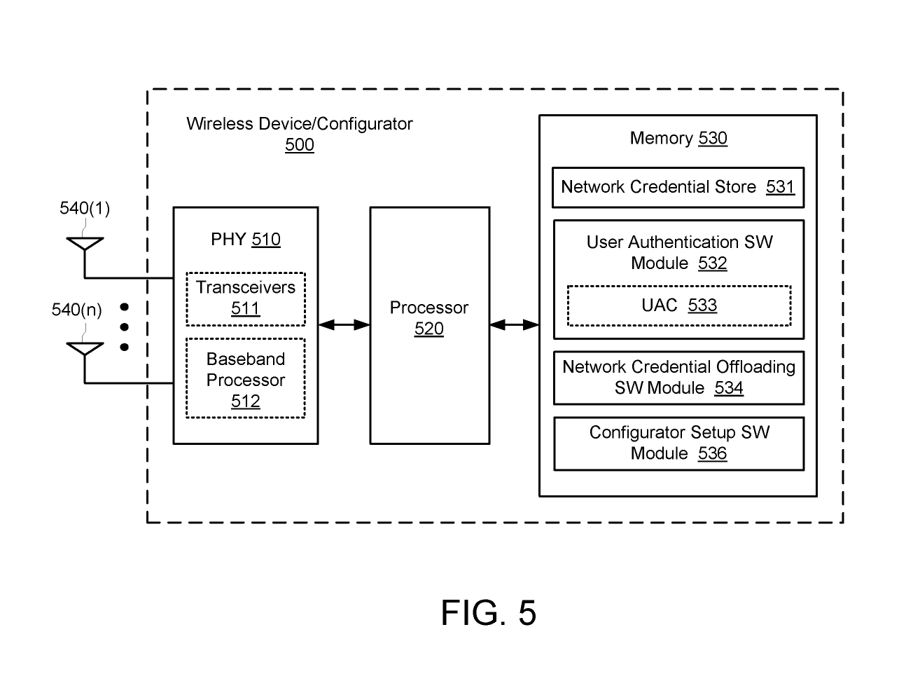

FIG. 5 shows a block diagram of a wireless device 500 in accordance with example embodiments. The wireless device 500 may be one embodiment of wireless device 230 of FIG. 2. The wireless device 500 may also be one embodiment of configurator 140 of FIG. 1 and/or configurator 220 of FIG. 2. The wireless device 500 includes at least a PHY device 510, a processor 520, memory 530, and a number of antennas 540(1)-540(n).

The PHY device 510 includes at least a set of transceivers 511 and a baseband processor 512. The transceivers 511 may be coupled to antennas 540(1)-540(n), either directly or through an antenna selection circuit (not shown for simplicity). The transceivers 511 may be used to transmit signals to and receive signals from other wireless devices (e.g., APs, client devices, and/or other wireless devices), and may be used to scan the surrounding environment to detect and identify nearby wireless devices (e.g., within wireless range of the wireless device 500). The baseband processor 512 may be used to process signals received from processor 520 and/or memory 530 and to forward the processed signals to transceivers 511 for transmission via one or more antennas 540(1)-540(n). The baseband processor 512 may also be used to process signals received from one or more antennas 540(1)-540(n) via transceivers 511 and to forward the processed signals to the processor 520 and/or memory 530.

Memory 530 may include a network credential store 531 that stores a set of network credentials used for authorizing devices (e.g., member devices) to access the WLAN. For some embodiments, the network credential store 531 may store identity key information (e.g., public root identity keys) for each member of the WLAN (e.g., for public key whitelist-based access control). For other embodiments, the network credential store 531 may store a pair of certification authority (CA) public and private keys that may be used to certify communications by member devices (e.g., for certificate-based access control).

Memory 530 may also include a non-transitory computer-readable medium (e.g., one or more nonvolatile memory elements, such as EPROM, EEPROM, Flash memory, a hard drive, etc.) that may store at least the following software (SW) modules:

a user authentication SW module 532 to acquire a user authentication credential (UAC) 533 from a user of the wireless device 500;

a network credential offloading SW module 534 to offload and/or distribute the network credentials stored in the network credential store 531 to one or more member devices (e.g., APs) of the WLAN; and

a configurator setup SW module 536 to configure and/or operate the wireless device 500 as a configurator for the WLAN.

Each software module includes instructions that, when executed by the processor 520, cause the wireless device 500 to perform the corresponding functions. The non-transitory computer-readable medium of memory 530 thus includes instructions for performing all or a portion of the configurator-side operations and/or wireless device-side operations depicted in FIG. 7.

Processor 520 may be any suitable one or more processors capable of executing scripts or instructions of one or more software programs stored in the wireless device 500 (e.g., within memory 530). For example, processor 520 may execute the user authentication SW module 532 to acquire a user authentication credential 533 from a user of the wireless device 500. The processor 520 may also execute the network credential offloading SW module 534 to offload and/or distribute the network credentials stored in the network credential store 531 to one or more member devices (e.g., APs) of the WLAN. Still further, the processor 520 may execute the configurator setup SW module 536 to configure and/or operate the wireless device 500 as a configurator for the WLAN.

FIG. 6 shows an illustrative flowchart depicting an operation 600 for distributing network credentials for a wireless network, in accordance with example embodiments. With reference, for example, to FIG. 2, the example operation 600 may be performed by the AP 210 to distribute and/or transfer the set of network credentials 222 from the configurator 220 to the wireless device 230.

The AP 210 first receives a set of network credentials from a configurator (610). For example, the AP 210 may receive the network credentials 222 from the configurator 220 upon authenticating to the configurator 220 and/or periodically thereafter (e.g., or in response to changes to the network credentials 222). The network credentials 222 may be used to limit access to the wireless network to trusted and/or authenticated devices (e.g., members of the wireless network). In some aspects, the network credentials 222 may include a list of public root identity keys for trusted member devices (e.g., for public key whitelist-based access control). In other aspects, the network credentials 222 may include a pair of CA public and private keys that may be used by a certification authority to sign and/or certify communications by member devices (e.g., for certificate-based access control).

The AP 210 may receive a user authentication credential (UAC) from a wireless device (620). For example, the AP 210 may receive the user authentication credential 232 from the wireless device 230. More specifically, the user 201 of the wireless device 230 may provide the user authentication credential 232 via one or more input features (e.g., microphone, camera, touchscreen, keyboard, etc.) of the wireless device. In some embodiments, the user authentication credential 232 may include an alphanumeric password. In other embodiments, the user authentication credential 232 may include an audio recording and/or voice data. Still further, in some embodiments, the user authentication credential 232 may include a photo and/or image data.

The AP 210 may then authenticate the wireless device as a new configurator based at least in part on the user authentication credential (630). The example embodiments recognize that the same user 201 may own and/or operate both the wireless device 230 and the configurator 220. Thus, the AP 210 may determine the trustworthiness of the wireless device 230 by authenticating the user 201 (e.g., rather than merely authenticating the wireless device 230). For example, the AP 210 may compare the user authentication credential 232 form the wireless device 230 with a stored user authentication credential 224 (e.g., which may be previously received from the configurator 220) to determine whether the same user 201 input both user authentication credentials 224 and 232. The AP 210 may authenticate the wireless device as a new configurator if the user authentication credential 232 from the wireless device 230 substantially matches the stored user authentication credential 224.

Finally, the AP 210 may transmit the network credentials to the wireless device upon authenticating the wireless device as the new configurator (640). For example, the AP 210 may distribute a copy of the network credentials 222 to the wireless device 230 to enable the wireless device 230 to serve as a backup and/or provide redundancy for the configurator 220. Furthermore, by storing a local copy of the network credentials 222, the wireless device 230 may assume the role of the configurator 220 (e.g., and thus maintain the membership of the wireless network) in the event that the configurator 220 becomes lost, stolen, replaced, and/or otherwise removed from the wireless network.

FIG. 7 shows an illustrative flowchart depicting an operation 700 for on-boarding a new configurator in a wireless network, in accordance with example embodiments. With reference, for example, to FIG. 2, the example operation 700 may be carried out by the AP 210, configurator 220, and wireless device 230, to on-board the wireless device 230 as a configurator for the wireless network.

The configurator 220 receives a first user authentication credential (UAC₀) from a user of the configurator 220 (702). As described above, the first user authentication credential UAC₀ may include an alphanumeric password, a voice recording, image, and/or other information that uniquely identifies the user 201 of the configurator 220. More specifically, the user 201 may input the first user authentication credential UAC₀ on the configurator 220 using one or more input features (e.g., microphone, camera, touchscreen, keyboard, etc.) of the configurator 220.

The configurator 220 then sends a set of network credentials (NC), with the first user authentication credential UAC₀, to the AP 210 (704). For example, the configurator 220 may distribute a copy of the network credentials 222 (e.g., for authorizing and/or limiting access to the wireless network to member devices) to be stored on or by the AP 210. For some embodiments, the network credentials 222 may be redistributed (e.g., by the AP 210) to other devices. Accordingly, the first user authentication credential UAC₀ may serve as a “reference credential” for verifying a trustworthiness (e.g., user) of any device attempting to acquire a copy of the network credentials 222.

The AP 210 stores the network credentials and the first user authentication credential UAC₀ from the configurator 220 (706). For some embodiments, the AP 210 may request the first user authentication credential UAC₀ after first receiving a copy of the network credentials 222 from the configurator 220. For example, upon receiving the network credentials 222, the AP 210 may send a UAC request to the configurator 220, causing the configurator 220 to prompt the user 201 to input or provide the first user authentication credential UAC₀. In example embodiments, the AP 210 may use the network credentials 222 and first user authentication credential UAC₀ to on-board new configurator devices. For example, the AP 210 may on-board the wireless device 230 as a configurator for the wireless network.

The wireless device 230 receives a second user authentication credential (UAC₁) from a user of the wireless device 230 (708). The second user authentication credential UAC₁ may be of the same format and/or type as the first user authentication credential UAC₀. For example, the second user authentication credential UAC₁ may include an alphanumeric password, a voice recording, image, and/or other information that uniquely identifies the user 201 of the wireless device 230. Specifically, the user 201 may input the second user authentication credential UAC₁ using one or more input features (e.g., microphone, camera, touchscreen, keyboard, etc.) of the wireless device 230.

The wireless device 230 further establishes a secure channel of communications with the AP 210 (710). In example embodiments, the wireless device 230 may establish the secure channel in accordance with a DPP protocol. For example, the wireless device 230 may acquire a public root identity key of the AP 210 in an out-of-band manner (e.g., using a QR code, BLE communication, NFC communication, USB connection, label string, etc.), to ensure that the AP 210 is a trusted device. The wireless device 230 may then initiate a DPP authentication process with the AP 210 to establish the secure communications channel (e.g., via an exchange of encrypted messages). During the authentication process, the wireless device 230 may provide its own public root identity key to the AP 210.

The wireless device 230 then sends the second user authentication credential UAC₁ to the AP 210 via the secure communication channel (712). For example, the wireless device 230 may encrypt the second user authentication credential UAC₁ using its own private root identity key. The AP 210 may then decrypt the second user authentication credential UAC₁ using the public root identity key of the wireless device 230 (e.g., received during the DPP authentication process).

The AP 210 may compare the second user authentication credential UAC₁ to the first user authentication credential UAC₀ to verify the user 201 of the wireless device 230 (714). In example embodiments, the AP 210 may determine whether the user 201 of the wireless device 230 is the same as the user 201 of the configurator 220 based on the comparison. If the second user authentication credential UAC₁ does not match the first user authentication credential UAC₀ (716), the AP 210 may terminate the configurator setup of the wireless device 230 (718). For example, the AP 210 may send a message to the wireless device 230 indicating that the wireless device 230 (and/or user of the wireless device 230) could not be authenticated.

If the second user authentication credential UAC₁ substantially matches the first user authentication credential UAC₀ (as tested at 716), the AP 210 may proceed to send the stored network credentials to the wireless device 230 (720), and enable the wireless device 230 to operate as a configurator for the wireless network using the network credentials (722). For example, the wireless device 230 may receive a copy of the network credentials 222 from the AP 210, and may subsequently use the network credentials 222 to provide and/or limit access to the wireless network to member devices. Accordingly, the wireless device 230 may provide redundancy for the configurator 220 and/or preserve the membership of the wireless network in the event the configurator 220 becomes lost, stolen, replaced, or otherwise removed from the wireless network.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences, or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, the example embodiments have been described with reference to specific example embodiments thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method of distributing network credentials for a wireless network, the method being performed by a first device of the wireless network and comprising:
receiving, from a first configurator, a set of network credentials used to authorize one or more devices to access the wireless network;
receiving a user authentication credential from a second device;
authenticating the second device as a second configurator for the wireless network based at least in part on the user authentication credential; and
transmitting the set of network credentials to the second configurator.

2. The method of claim 1, wherein the set of network credentials includes a list of trusted public keys associated with the one or more devices.

3. The method of claim 1, wherein the set of network credentials includes a pair of public and private keys used to certify the one or more devices as members of the wireless network.

4. The method of claim 1, further comprising:
receiving a reference credential from the first configurator.

5. The method of claim 4, wherein the authenticating comprises:
comparing the user authentication credential with the reference credential; and
authenticating the second device as the second configurator upon determining that the user authentication credential substantially matches the reference credential.

6. The method of claim 5, further comprising:
offloading the comparison to be performed by one or more processing resources external to the wireless network.

7. The method of claim 1, wherein the user authentication credential includes at least one of a password, voice data, or image data input by a user of the second device.

8. The method of claim 1, wherein receiving the user authentication credential comprises:
establishing a secure channel with the second device based at least in part on a public identity key of the first device; and
receiving the user authentication credential, from the second device, via the secure channel.

9. The method of claim 8, wherein the public identity key is provided to the second device in an out-of-band manner.

10. The method of claim 1, wherein the authenticating comprises:
enabling the second device to authorize additional devices to access the wireless network.

11. A wireless device comprising:
one or more processors; and
a memory storing instructions that, when executed by the one or more processors, cause the wireless device to:
receive, from a first configurator, a set of network credentials used to authorize one or more devices to access a wireless network;
receive a user authentication credential from another wireless device;
authenticate the other wireless device as a second configurator for the wireless network based at least in part on the user authentication credential; and
transmit the set of network credentials to the second configurator.

12. The wireless device of claim 11, wherein the set of network credentials includes a list of trusted public key associated with the one or more devices.

13. The wireless device of claim 11, wherein the set of network credentials includes a pair of public and private keys used to certify the one or more devices as members of the wireless network.

14. The wireless device of claim 11, wherein execution of the instructions further causes the wireless device to:
receive a reference credential from the first configurator.

15. The wireless device of claim 14, wherein execution of the instructions to authenticate the other wireless device causes the wireless device to:
compare the user authentication credential with the reference credential; and
authenticate the other wireless device as the second configurator upon determining that the user authentication credential substantially matches the reference credential.

16. The wireless device of claim 11, wherein the user authentication credential includes at least one of a password, voice data, or image data input by a user of the other wireless device.

17. The wireless device of claim 11, wherein execution of the instructions to receive the user authentication credential causes the wireless device to:
establish a secure channel with the other wireless device based at least in part on a public identity key of the wireless device, wherein the public identity key is provided to the other wireless device in an out-of-band manner; and
receive the user authentication credential, from the other wireless device, via the secure channel.

18. The wireless device of claim 11, wherein execution of the instructions to authenticate the other wireless device causes the wireless device to:
enable the other wireless device to authorize additional devices to access the wireless network.

19. The wireless device of claim 11, wherein the wireless device is a wireless access point (AP).

20. A wireless device comprising:
means for receiving, from a first configurator, a set of network credentials used to authorize one or more devices to access a wireless network;
means for receiving a user authentication credential from another wireless device;
means for authenticating the other wireless device as a second configurator for the wireless network based at least in part on the user authentication credential; and
means for transmitting the set of network credentials to the second configurator.

21. The wireless device of claim 20, wherein the set of network credentials includes a list of trusted public keys associated with the one or more devices.

22. The wireless device of claim 20, wherein the set of network credentials includes a pair of public and private keys used to certify the one or more devices as members of the wireless network.

23. The wireless device of claim 20, wherein the means for authenticating the other wireless device is to:
compare the user authentication credential with a reference credential received from the first configurator; and
authenticate the other wireless device as the second configurator upon determining that the user authentication credential substantially matches the reference credential.

24. The wireless device of claim 20, wherein the user authentication credential includes at least one of a password, voice data, or image data input by a user of the other wireless device.

25. The wireless device of claim 20, wherein the means for receiving the user authentication credential is to:
establish a secure channel with the other wireless device based at least in part on a public identity key of the wireless device, wherein the public identity key is provided to the other wireless device in an out-of-band manner; and
receive the user authentication credential, from the other wireless device, via the secure channel.

26. The wireless device of claim 20, wherein the means for authenticating the other wireless device is to:
enable the other wireless device to authorize additional devices to access the wireless network.

27. A non-transitory computer-readable medium storing instructions that, when executed by a processor of a wireless device, causes the wireless device to:
receive, from a first configurator, a set of network credentials used to authorize one or more devices to access a wireless network;
receive a user authentication credential from another wireless device;
authenticate the other wireless device as a second configurator for the wireless network based at least in part on the user authentication credential; and
transmit the set of network credentials to the second configurator.

28. The non-transitory computer-readable medium of claim 27, wherein the set of network credentials includes a list of trusted public keys associated with the one or more devices.

29. The non-transitory computer-readable medium of claim 27, wherein the set of network credentials includes a pair of public and private keys used to certify the one or more devices as members of the wireless network

30. The non-transitory computer-readable medium of claim 27, wherein the user authentication credential includes at least one of a password, voice data, or image data input by a user of the other wireless device.
